(19) United States
(12) Patent Application Publication
(10) Pub. No.: US 2011/0062623 A1
(43) Pub. Date: Mar. 17, 2011

(54) METHOD OF FORMING A PATTERN FORMATION TEMPLATE

(76) Inventor: Masato SAITO, Machida-shi (JP)

(21) Appl. No.: 12/881,844

(22) Filed: Sep. 14, 2010

(30) Foreign Application Priority Data
Sep. 17, 2009 (JP) 2009-216074

(51) Int. Cl. B29C 33/42

(52) U.S. Cl. 264/219

(57) ABSTRACT

According to one embodiment, a concavo-convex pattern of a first template where a concavo-convex main pattern has been formed in a main pattern region and a concavo-convex peripheral pattern has been formed in a peripheral region is transferred to a second template substrate by imprint techniques. Then, a second template with a step between a region corresponding to the main pattern region and a region corresponding to the peripheral region is formed by retreating the peripheral region of the second template substrate by etching.

### CROSS-REFERENCE TO RELATED APPLICATIONS

This application is based upon and claims the benefit of priority from Japanese Patent Application No. 2009-216074, filed Sep. 17, 2009; the entire contents of which are incorporated herein by reference.

### FIELD

Embodiments described herein relate generally to a method of forming a pattern formation template for forming a second template from a first template by imprint techniques.

### BACKGROUND

In recent years, optical imprint techniques (step-and-flash imprint lithography [SFIL]) have been proposed as pattern transfer techniques for realizing the microfabrication of a semiconductor integrated circuit. In a template used in optical imprint techniques, a region where a desired transfer pattern has a concave-convex shape is called a mesa region (main pattern region), which differs from a peripheral region in surface height. In the peripheral region, there are provided alignment marks for adjusting the template pressing positions.

In the manufacture of semiconductor integrated circuits, a large number of the same patterns must be formed. Consequently, the template is used very often and therefore the risk of the template being broken is high. To overcome this problem, a first template is formed by electron beam lithography and a second template used in actual pattern transfer is formed from the first template by imprint techniques.

The pattern on the mesa region of the first template is transferred to the second template. Since the pattern outside the mesa region differs from the pattern on the mesa region in surface height, the pattern outside the mesa region is not transferred to the second template. Therefore, in the second template, after the main pattern and then a mesa structure have been formed, alignment marks must be formed outside the mesa region of the second template by an additional process.

However, when an alignment mark is formed outside the mesa region with a laser beam machine, there is a relative displacement of the position of the alignment mark formed outside the mesa region by additional machining from the position of the already formed main pattern because of the processing accuracy of the laser beam machine and the alignment accuracy of the processed position. If the pattern is transferred to a processed substrate using a template with such a positional accuracy error, the transfer positional control accuracy in pattern transfer will decrease.

### BRIEF DESCRIPTION OF THE DRAWINGS

FIG. 1 is a sectional view schematically showing a structure of a first template used in a first embodiment;

FIG. 2 is a sectional view schematically showing a structure of a second template formed in the first embodiment;

FIGS. 3A, 3B, 3C, 3D, 3E and 3F are sectional views to explain the steps of manufacturing the first template in the first embodiment;

FIGS. 4A, 4B, 4C, 4D, 4E, 4F, 4G, 4H and 4I are sectional views to explain the steps of manufacturing the second template in the first embodiment; and

FIGS. 5A and 5B are sectional views to explain the difference between the presence and absence of the mesa region in pattern transfer.

### DETAILED DESCRIPTION

In general, according to one embodiment, a concavo-convex pattern of a first template where a concavo-convex main pattern has been formed in a main pattern region and a concavo-convex peripheral pattern has been formed in a peripheral region is transferred to a second template substrate by imprint techniques. Then, a second template with a step between a region corresponding to the main pattern region and a region corresponding to the peripheral region is formed by retreating the peripheral region of the second template substrate by etching.

Hereinafter, referring to the accompanying drawings, embodiments of the invention will be explained.

### First Embodiment

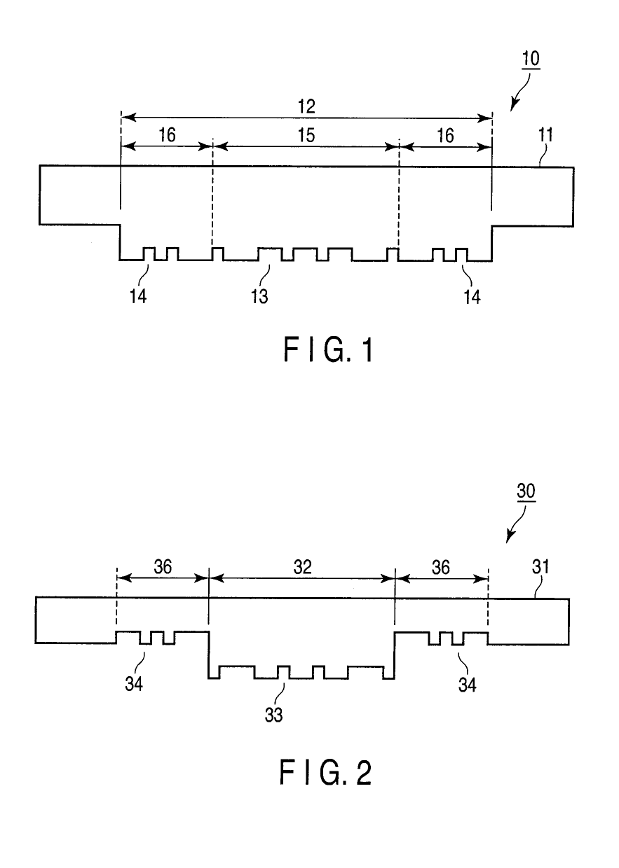

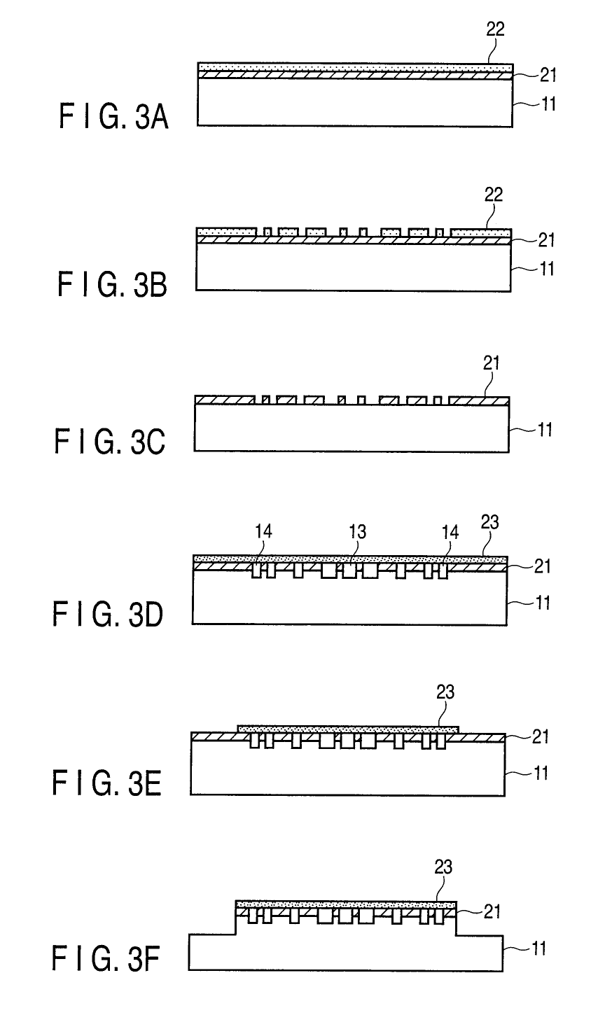

FIG. 1 is a sectional view schematically showing a configuration of a first template used in a first embodiment. FIG. 2 is a sectional view schematically showing a second template formed by imprint techniques using the first template.

As shown in FIG. 1, a first template 10 is configured by providing patterns 13, 14 at one principal surface of a substrate 11. At the front face (the undersurface in FIG. 1) of the substrate 10, a mesa region 12 which is convex except for its periphery is formed. In the mesa region 12, a main pattern 13 and alignment marks (peripheral marks) 14 are formed. The main pattern 13 is formed in a main pattern region 15 of the mesa region 12. The alignment marks 14 are formed in a peripheral region 16 of the mesa region 12. Each of the patterns 13, 14 is a concave-convex pattern formed by carving the surface of the substrate 11.

The substrate 11 is made of a translucent material, such as quartz, used in imprint techniques. The first template 10 is formed with a high accuracy by electronic beam lithography.

As shown in FIG. 2, a second template 30 is configured by providing patterns 33, 34 at one principal surface of a substrate 31. At the front face (the undersurface) of the substrate 31, a mesa region 32 which is convex in its central part is formed. In the mesa region 32, a main pattern 33 is formed. In a peripheral region 36 outside the mesa region 32, alignment marks (peripheral patterns) 34 are formed. That is, the mesa region includes only the main pattern region, not the peripheral region 36. Each of the patterns 33, 34 is formed by imprint techniques using the template 10. Like the substrate 11, the substrate 31 is made of a translucent material, such as quartz, used in imprint techniques.

As described above, the size of the mesa region in the first template 10 differs from that of the mesa region in the second template 30. In addition, the alignment marks 14 are formed in the mesa region 12 of the first template 10, whereas the alignment marks 34 are formed in the peripheral region 36 outside the mesa region 32.

Next, a method of manufacturing the first template 10 and second template 30 will be explained.

In the embodiment, the alignment marks 14 formed in the mesa region 12 of the first template 10 are transferred to a region outside the mesa region 32 of the second template 30. Then, while the relative positional accuracy between the main pattern and the alignment marks in processing the first template is maintained, the alignment marks 34 are formed outside the mesa region 32 of the second template 30.

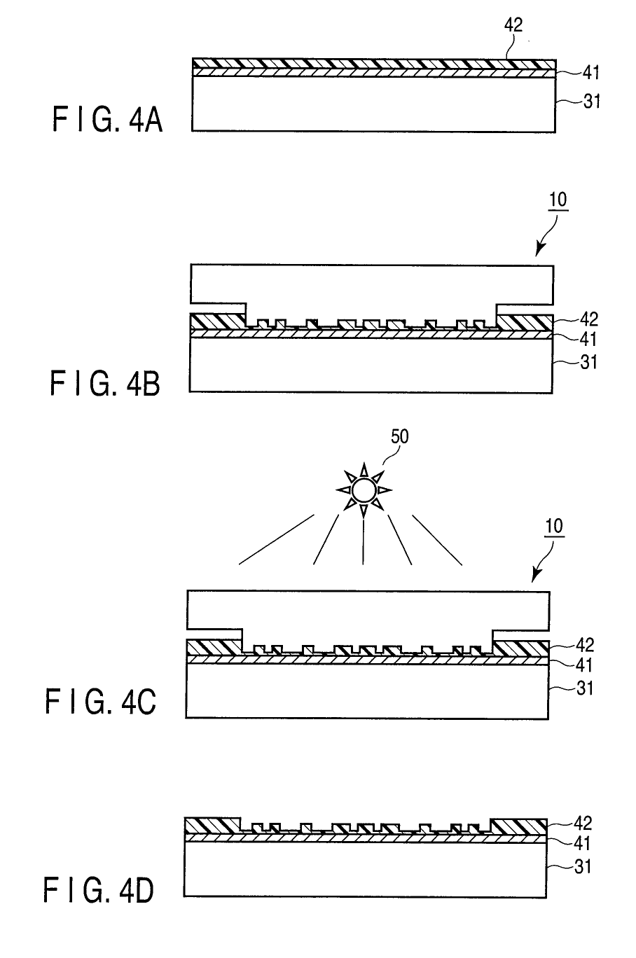

FIGS. 3A to 3F are sectional views to explain the steps of manufacturing the first template 10 in the first embodiment.

First, as shown in FIG. 3A, a substrate 11 for forming a first template 10 is prepared. In the embodiment, a Qz substrate with dimensions of about 152 mm×152 mm×6 mm thick is used as the substrate 11. On the substrate 11, a Cr film 21 about 10 nm thick is formed by sputtering. EB resist 22 is applied onto the Cr film 21.

Then, a pattern used for transfer by imprint techniques is exposed on the EB resist 22 on the substrate 11 with an electron beam lithography system. At this time, the pattern includes not only the main pattern 13 but also the alignment marks 14. Then, the EB resist 22 in the exposed part is removed by a processing procedure, thereby forming a resist pattern serving as an etching mask as shown in FIG. 3B.

Next, as shown in FIG. 3C, with the EB resist film 22 as a mask, the Cr film 21 is etched. Thereafter, the EB resist 22 is peeled.

Then, as shown in FIG. 3D, with the Cr film 21 as a mask, carve etching is applied to the surface of the substrate 11, thereby forming the main pattern 13 and alignment marks 14. In the embodiment, anisotropic dry etching is used. In the anisotropic dry etching, a fluorine radical is used in carve etching. Thereafter, photosensitive resin (photoresist) 23 is applied to the substrate 11.

Next, as shown in FIG. 3E, the photoresist 23 in the part excluding the mesa region 12 is exposed. At this time, the mesa region 12 is set so that the region where the alignment marks 14 have been formed may be inside the mesa region 12. Thereafter, the photoresist 23 in the exposed part is removed by a processing procedure.

Then, as shown in FIG. 3F, with the photoresist 23 as a mask, the Cr film 21 is etched. Then, with the photoresist film 23 and Cr film 21 as a mask, carve etching is applied to the substrate 11. In the embodiment, anisotropic dry etching using a fluorine radical is used as carve etching.

From this point on, the resist 23 and Cr film 21 are peeled, which completes a first template 10 which has the structure shown in FIG. 1.

As shown in FIG. 1, in the first template 10, the main pattern 13 and alignment marks 14 are both in the mesa region 12. Since the main pattern 13 and alignment marks 14 are both exposed in the same process, both have the same positional accuracy and therefore there is no relative positional error.

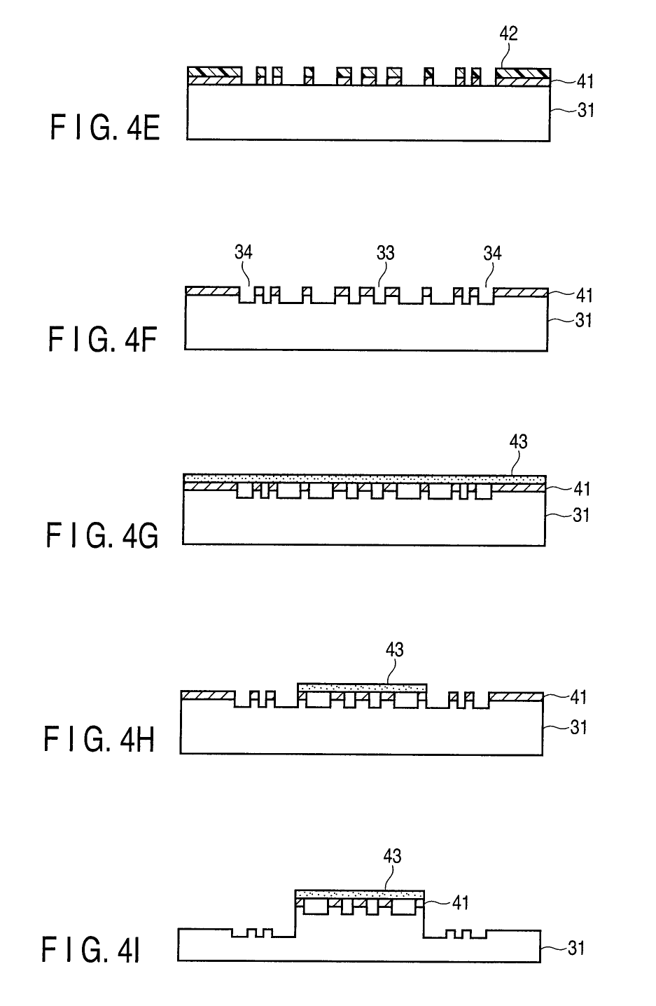

FIGS. 4A to 4I are sectional views to explain the steps of manufacturing a second template 30 by optical imprint techniques. A first template 10 used here is the one formed by the processes shown in FIGS. 3A to 3F.

First, as shown in FIG. 4A, a substrate 31 for forming a second template 30 is prepared. In the embodiment, a Qz substrate with dimensions of about 152 mm×152 mm×6 mm thick is used as the substrate 31. On the substrate 31, a Cr film 41 about 10 nm thick is formed by sputtering. Light curing resin 42 is applied onto the Cr film 41.

Next, as shown in FIG. 4B, a concave-convex pattern formed at the surface of the first template 10 is pressed against the light curing resin 42 applied onto the substrate 31 in such a manner that the light curing resin 42 spreads over the concavo-convex pattern at the surface of the first template 10.

Then, as shown in FIG. 4C, a light source 50 is caused to apply light from the back side of the first template 10, thereby hardening the light curing resin 42. Thereafter, as shown in FIG. 4D, the first template 10 is peeled from the substrate 31 for forming a second template.

Next, as shown in FIG. 4E, with the hardened light curing resin 42 as a mask, the Cr film 41 is selectively etched by RIE techniques. Thereafter, the light curing resin film 42 is peeled.

Then, as shown in FIG. 4F, with the Cr film 41 as a mask, carve etching is applied to the surface of the substrate 31, thereby forming a main pattern 33 and alignment marks 34 at the surface of the substrate 31. In the embodiment, anisotropic dry etching using a fluorine radical is used to carve the substrate.

Next, as shown in FIG. 4G, photosensitive resin (photoresist) 43 is applied onto the substrate 31. Then, the photoresist 43 in the part excluding the mesa region 32 is exposed. At this time, the mesa region 32 is set so that the region where the alignment marks 34 have been formed may be in a peripheral region 36 outside the mesa region 32. Thereafter, as shown in FIG. 4H, the photoresist 43 in the exposed part is removed by a processing procedure.

Next, as shown in FIG. 4I, with the photoresist 43 as a mask, the Cr film 41 is etched. Then, with the photoresist film 43 and Cr film 41 as a mask, carve etching is applied to the surface of the substrate. In the embodiment, anisotropic dry etching using a fluorine radical is used. At this time, the part where the alignment marks 34 have been formed is also etched. Because of anisotropic dry etching, the substrate surface in the part excluding the mesa region 32 is carved, while the concavo-convex structure before etching is maintained.

From this point on, the photoresist 43 and Cr film 41 are peeled, which completes a second template 30 which has the structure shown in FIG. 2.

In the second template 30, the alignment marks 34 have been formed outside the mesa region 32. In this case, some error in the dimensional accuracy and carve depth accuracy of the alignment marks 34 occurs in the process of forming a mesa structure. However, no new error occurs in the relative positional accuracy between the alignment marks 34 and main pattern 33 and therefore the same accuracy as that of the first template 10 is maintained. That is, the alignment marks 34 and main pattern 33 have the same positional accuracy and therefore there is no relative positional error.

Forming the second template 30 by the above processes enables the alignment marks 34 to be formed outside the mesa region 32 without degrading the relative positional accuracy between the main pattern 33 and alignment marks 34. In addition, use of the template 30 formed by the above processes enables a pattern to be transferred with high accuracy by optical imprint techniques.

The reason why the mesa structure is needed in the template 30 is to avoid the breakage of the previously transferred patterns due to the interference with adjacent patterns and the template used when a plurality of patterns are transferred to the same processed substrate.

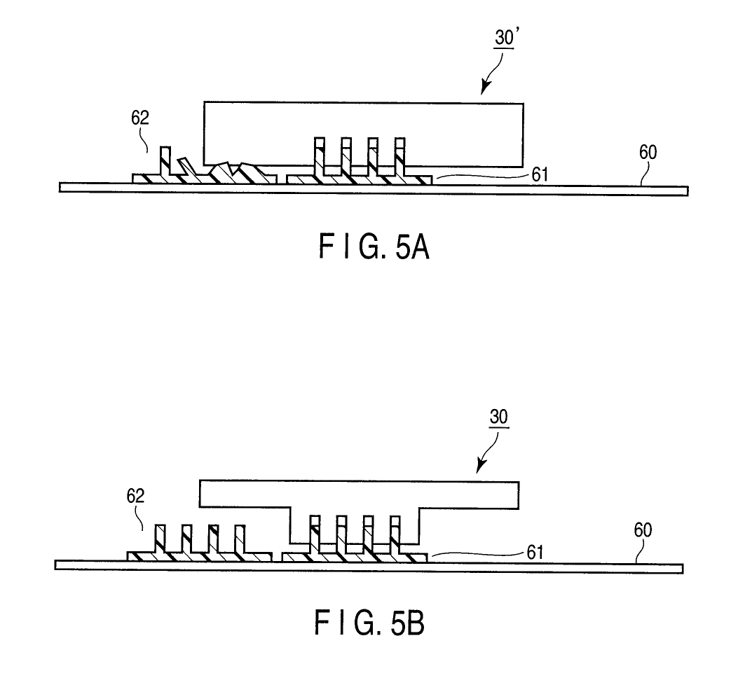

FIG. 5A shows a case where a pattern has been transferred using a template 30′ with no mesa structure. It is seen that, when a pattern 61 is formed on a semiconductor substrate 60 using the template 30′, a previously transferred pattern 62 has been broken due to the interference with the template 30′. FIG. 6B shows a case where a pattern has been transferred using a template 30 with such a mesa structure as described in the first embodiment. It is seen that, even when a pattern 61 is formed on a semiconductor substrate 60 using the template 30, the interference of the mesa structure with adjacent patterns 62 is avoided and therefore the pattern is transferred without breaking the adjacent pattern 62.

As described above, with the embodiment, the alignment marks 34 can be formed outside the mesa region 32 in the second template 30, while the relative positional accuracy with the main pattern 33 is kept good. Specifically, the second template 30 can be formed from the first template 10 by imprint techniques and the alignment marks 34 can be formed in the peripheral region 36 with high accuracy without impairing the relative positional accuracy between the main pattern 33 and alignment marks 34 in the second template 30. Accordingly, a pattern is formed by optical imprint techniques using the second template 30, which makes it possible to form a pattern with good positional accuracy

(Modification)

This invention is not limited to the above embodiment.

The structure and size of the substrate for forming a template explained in the embodiment are illustrative and not restrictive. The size of the template substrate may be different from that described in the embodiment. The substrate for forming a template is not necessarily made of Qz. Any suitable material may be used, provided that the material has a translucency and rigidity that pose no problem in using optical imprint techniques. The Cr layer on the surface of the substrate used in the embodiment is an example of the material suitable for a mask member in etching Qz and the layer may be made of a suitable metal other than Cr or a suitable nonmetal.

The processes used in the embodiment do not restrict the scope of the invention. While in the embodiment, an electron beam lithographic system has been used as lithographic means used to form a first template pattern, a laser beam lithographic system, an ion beam lithographic system, or the like may be used, provided that the system satisfies the required specifications, including accuracy. In this case, the type of resist used may be changed according to the lithographic system used. In addition, imprint techniques in forming a second template are not necessarily restricted to optical imprint techniques. For instance, thermal imprint techniques using thermosetting resin instead of light curing resin may be used.

While in the embodiment, anisotropic dry etching using a fluorine radical has been used as means for etching Qz, other techniques, including wet etching using fluorine series solution, may be used, provided that a desired processing accuracy is obtained. When isotropic etching has been used in wet etching, the alignment marks will have become deformed and changed in size. If the alignment marks have been etched isotropically and reflected their original shape, they can be used as alignment marks. For instance, if relatively large alignment marks have been formed in the first template, small alignment marks that reflect the shape of the original marks will be left in isotropically etching the second template. In this case, too, an error in the relative position between the main pattern and alignment marks can be prevented.

The peripheral pattern is not necessarily limited to the alignment marks and may be any pattern other than the main pattern, such as identifying marks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of forming a pattern formation template, comprising:
preparing a first template where a concavo-convex main pattern has been formed in a main pattern region and a concavo-convex peripheral pattern has been formed in a peripheral region and transferring the concavo-convex pattern of the first template to a second template substrate by imprint techniques; and
forming a second template with a step between a region corresponding to the main pattern region and a region corresponding to the peripheral region by masking a region corresponding to the main pattern region of the second template substrate to which the concavo-convex pattern has been transferred and then retreating a region corresponding to the peripheral pattern of the second template substrate by etching.

2. The method according to claim 1, wherein the transferring the concavo-convex pattern of the first template to the second template substrate includes
forming a processed film to be cured by light or heat on the second template substrate and selectively etching the substrate with the processed film as a mask after transferring the concavo-convex pattern of the first template to the processed film by the imprint techniques.

3. The method according to claim 2, wherein the transferring the concavo-convex pattern of the first template to the processed film by the imprint techniques includes
forming a light curing resin as the processed film and curing the processed film by applying light from the back side of the first template substrate while the first template is pressed against the second template substrate and then peeling the first template from the second template substrate.

4. The method according to claim 1, wherein the retreating a region corresponding to the peripheral pattern of the second template substrate includes
forming a mask material film on a region corresponding to the main pattern region of the second template substrate and then anisotropically etching the region corresponding to the peripheral region of the second template substrate.

5. The method according to claim 1, wherein the retreating a region corresponding to the peripheral pattern of the second template substrate includes
forming a mask material film on a region corresponding to the main pattern region of the second template substrate and then isotropically etching the region corresponding to the peripheral region of the second template substrate.

6. The method according to claim 1, wherein the peripheral pattern in the peripheral region is alignment marks used to align template pressing positions.

7. The method according to claim 1, wherein the first template is formed by electron beam lithography.

8. A method of forming a pattern formation template, comprising:
forming by electron beam lithography a first template which has a concavo-convex main pattern in a main pattern region and a concavo-convex peripheral pattern in a peripheral region;
transferring the concavo-convex pattern of the first template to a second template substrate by imprint techniques; and
forming a second template with a step between a region corresponding to the main pattern region and a region corresponding to the peripheral region by masking a region corresponding to the main pattern region of the second template substrate to which the concavo-convex pattern has been transferred and then retreating a region corresponding to the peripheral pattern of the second template substrate by etching.

9. The method according to claim 8, wherein the transferring the concavo-convex pattern of the first template to the second template substrate includes
forming a processed film to be cured by light or heat on the second template substrate and selectively etching the substrate with the processed film as a mask after transferring the concavo-convex pattern of the first template to the processed film by the imprint techniques.

10. The method according to claim 9, wherein the transferring the concavo-convex pattern of the first template to the processed film by the imprint techniques includes
forming a light curing resin as the processed film and curing the processed film by applying light from the back side of the first template substrate while the first template is pressed against the second template substrate and then peeling the first template from the second template substrate.

11. The method according to claim 8, wherein the retreating a region corresponding to the peripheral pattern of the second template substrate includes
forming a mask material film on a region corresponding to the main pattern region of the second template substrate and then anisotropically etching the region corresponding to the peripheral region of the second template substrate.

12. The method according to claim 8, wherein the retreating a region corresponding to the peripheral pattern of the second template substrate includes
forming a mask material film on a region corresponding to the main pattern region of the second template substrate and then isotropically etching the region corresponding to the peripheral region of the second template substrate.

13. The method according to claim 8, wherein the peripheral pattern in the peripheral region is alignment marks used to align template pressing positions.

14. A method of manufacturing a semiconductor device, comprising:
preparing a first template where a concavo-convex main pattern has been formed in a main pattern region and a concavo-convex peripheral pattern has been formed in a peripheral region and transferring the concavo-convex pattern of the first template to a second template substrate by imprint techniques;
forming a second template with a step between a region corresponding to the main pattern region and a region corresponding to the peripheral region by masking a region corresponding to the main pattern region of the second template substrate to which the concavo-convex pattern has been transferred and then retreating a region corresponding to the peripheral pattern of the second template substrate by etching; and
transferring the pattern formed on the second template onto a semiconductor substrate by imprint techniques.

15. The method according to claim 14, wherein the transferring the concavo-convex pattern of the first template to the second template substrate includes
forming a processed film to be cured by light or heat on the second template substrate and selectively etching the substrate with the processed film as a mask after transferring the concavo-convex pattern of the first template to the processed film by the imprint techniques.

16. The method according to claim 14, wherein the transferring the concavo-convex pattern of the first template to the processed film by the imprint techniques includes
forming a light curing resin as the processed film and curing the processed film by applying light from the back side of the first template substrate while the first template is pressed against the second template substrate and then peeling the first template from the second template substrate.

17. The method according to claim 14, wherein the retreating a region corresponding to the peripheral pattern of the second template substrate includes
forming a mask material film on a region corresponding to the main pattern region of the second template substrate and then anisotropically etching the region corresponding to the peripheral region of the second template substrate.

18. The method according to claim 14, wherein the retreating a region corresponding to the peripheral pattern of the second template substrate includes
forming a mask material film on a region corresponding to the main pattern region of the second template substrate and then isotropically etching the region corresponding to the peripheral region of the second template substrate.

19. The method according to claim 14, wherein the peripheral pattern in the peripheral region is alignment marks used to align template pressing positions.

20. The method according to claim 14, wherein the imprint techniques for transferring the second template onto the semiconductor substrate are optical imprint techniques that transfer the pattern of the second template to the semiconductor substrate by applying light from the back side of the second template.
